(19) United States
(12) Patent Application Publication
(10) Pub. No.: US 2026/0051796 A1
(43) Pub. Date: Feb. 19, 2026

(54) METHOD AND SYSTEM FOR ASSEMBLING AN ELECTRIC CONVERTER

(71) Applicant: Ford Motor Company, Dearborn, MI (US)

(72) Inventors: Sarah Dziadzio, Livonia, MI (US); Alexander Marrocco, Windsor (CA); Nick Sochacki, Ann Arbor, MI (US); Clara Goldberg, Royal Oak, MI (US); James Cederstrom, Saint Clair Shores, MI (US)

(73) Assignee: Ford Motor Company, Dearborn, MI (US)

(21) Appl. No.: 18/802,765

(22) Filed: Aug. 13, 2024

(51) Int. Cl. H02K 15/02; H02K 1/22; H02K 7/00; H02K 15/12

(52) U.S. Cl. CPC H02K 15/02; H02K 1/22; H02K 7/003; H02K 15/12

(57) ABSTRACT

A method of assembling an electric converter. The method includes placing a stack of rotor cores on a base plate of a tool assembly, inserting a core shaft into an aperture of the stack of rotor cores so that the stack of rotor cores and the core shaft surround a heater, and turning on the heater to heat the core shaft such that the stack of rotor cores and the heated core shaft are joined together. A diameter of the aperture of the stack of rotor cores is greater than a diameter of the core shaft prior to inserting the core shaft into the aperture of the stack of rotor cores.

### FIELD

The present disclosure relates to a method and system for assembling an electric converter, more specifically, for assembling an electric converter including a stack of rotor cores and a shaft.

### BACKGROUND

The statements in this section merely provide background information related to the present disclosure and may not constitute prior art.

With the continuing electrification trend in motor vehicles, related components such as electric motors for electric vehicle powertrains are being developed for high volume production. These electric motors are complex assemblies, typically including a stack of rotor cores fixed to a shaft. Assembly of these electric motors can be time consuming and challenging given the complexity of the design of the rotor cores and their embedded magnets. Further, joining the stack of rotor cores to the shaft while achieving assembly efficiency for high volume production can be difficult.

These issues related to the manufacture of electric motors, including joining the stack of rotor cores to the shaft, are addressed by the present disclosure.

### SUMMARY

This section provides a general summary of the disclosure and is not a comprehensive disclosure of its full scope or all of its features.

In one form, the present disclosure provides a method of assembling an electric converter. The method includes placing a stack of rotor cores on a base plate of a tool assembly, inserting a core shaft into an aperture of the stack of rotor cores so that the stack of rotor cores and the core shaft surround a heater, and turning on the heater to heat the core shaft such that the stack of rotor cores and the heated core shaft are joined together. A diameter of the aperture of the stack of rotor cores is greater than a diameter of the core shaft prior to inserting the core shaft into the aperture of the stack of rotor cores.

In variations of the method of the above paragraph, which can be implemented individually or in any combination: the method further includes aligning the stack of rotor cores and the core shaft prior to inserting the core shaft into the aperture of the stack of rotor cores; the core shaft is cooled prior to being inserted into the aperture of the stack of rotor cores so that the diameter of the aperture of the stack of rotor cores is greater than the diameter of the core shaft; turning on the heater includes pulsating a current to the heater; the base plate and the core shaft cooperate to compress the stack of rotor cores in response to the core shaft being inserted into the aperture of the stack of rotor cores; the stack of rotor cores is heated prior to the core shaft being inserted into the aperture of the stack of rotor cores so that the diameter of the aperture of the stack of rotor cores is greater than the diameter of the core shaft; the core shaft is hollow, and wherein the heater is an induction coil disposed within the hollow core shaft.

In another form, the present disclosure provides a method of assembling an electric converter. The method includes heating a stack of rotor cores to a first temperature; cooling a core shaft to a second temperature, the second temperature being less than the first temperature so that a diameter of an aperture of the heated stack of rotor cores is greater than a diameter of the cooled core shaft; placing the heated stack of rotor cores on a base plate of a tool assembly; inserting the cooled core shaft into the aperture of the heated stack of rotor cores so that the heated stack of rotor cores and the cooled core shaft surround a heater, the base plate and the cooled core shaft cooperate to compress the heated stack of rotor cores when the cooled core shaft is inserted into the aperture of the heated stack of rotor cores; and turning on the heater to heat the cooled core shaft such that the heated stack of rotor cores and the heated core shaft are joined together.

In variations of the method of the above paragraph, which can be implemented individually or in any combination: the method further includes aligning the heated stack of rotor cores and the cooled core shaft prior to inserting the cooled core shaft into the aperture of the heated stack of rotor cores; turning on the heater includes pulsating a current to the heater; the heated stack of rotor cores and the heated core shaft are joined together by an interference fit; the base plate is movable between a first position in which the base plate is removed from the heater and a second position in which the base plate surrounds the heater, the heated stack of rotor cores is placed on the base plate when the base plate is in the first position and the cooled core shaft is inserted into the aperture of the heated stack of rotor cores when the base plate is in the second position; the core shaft is hollow, and the heater is an induction coil disposed within the hollow core shaft.

In another form, the present disclosure provides a system for assembling an electric converter including a stack of rotor cores and a core shaft. The system includes a heater, a base plate, a load applicator and a controller. The base plate surrounding the heater and configured to support the stack of rotor cores. The load applicator is configured to engage and move the core shaft between a first position in which the core shaft is removed from the stack of rotor cores and a second position in which the core shaft is inserted into the stack of rotor cores and surrounding the heater. The controller is in communication with the heater and the load applicator. The controller configured to: instruct the load applicator to move from the first position to the second position and turn on the heater in response to the load applicator being moved to the second position.

In variations of the system of the above paragraph, which can be implemented individually or in any combination: the system further includes an alignment shaft configured to align the stack of rotor cores and the core shaft and movable between a first state in which the alignment shaft surrounds the heater and a second state in which the alignment shaft is removed from the heater; the alignment shaft is biased towards the first state via a biasing element, and when the load applicator moves from the first state to the second state, the load applicator overcomes a biasing force of the biasing element to move the alignment shaft from the first state to the second state; the heater is an induction coil; the base plate is movable between a first position in which the base plate is removed from the heater and a second position in which the base plate surrounds the heater; and the controller is in communication with the base plate and configured to: instruct the base plate to move from the first position to the second position and instruct the load applicator to move from the first position to the second position in response the base plate being moved to the second position; the heater is fixed; and turning on the heater includes pulsating a current to the heater.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of an electric converter including a stack of rotor cores and a shaft assembled according to the teachings of the present disclosure;

FIG. 1B is a perspective view of the stack of rotor cores of the electric converter of FIG. 1A;

FIG. 1C is a perspective view of the shaft of the electric converter of FIG. 1A;

FIG. 2 is a schematic view of a system for assembling the stack of rotor cores and the shaft of FIG. 1;

FIG. 3 is an exploded view of a heater of the system of FIG. 2;

FIG. 4 is a perspective view of the heater of the system of FIG. 2;

FIG. 5 is a perspective view of the alignment shaft of the system of FIG. 2;

FIG. 6A is a schematic view of a stack of heated rotor cores being placed on a base plate of the system of FIG. 2;

FIG. 6B is a schematic view of the base plate containing the stack of heated rotor cores being moved from a first position to a second position;

FIG. 6C is a schematic view of a cooled shaft being inserted into the stack of heated rotor cores;

FIG. 6D is a schematic view of the heater of FIG. 3 heating the cooled shaft to join the stack of heated rotor cores and the heated shaft;

FIG. 7 is a functional block diagram of the system for assembling the stack of rotor cores of the electric converter to the shaft of the electric converter according to the principles of the present disclosure; and

FIG. 8 is a flow diagram illustrating a method of assembling the stack of rotor cores of the electric converter to the shaft of the electric converter according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

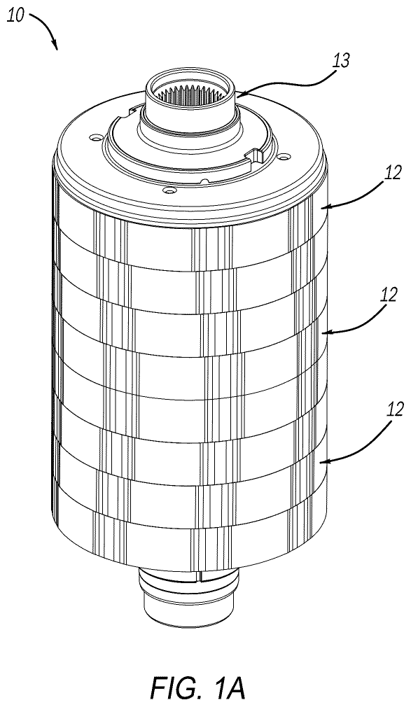

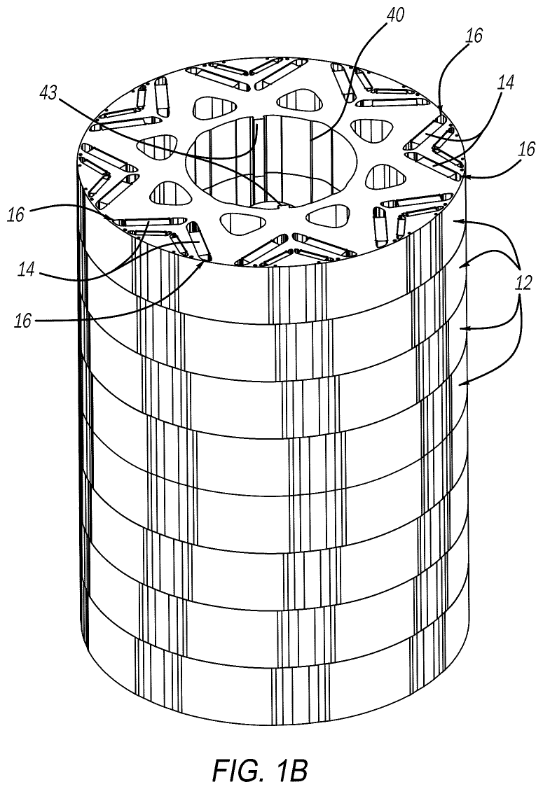

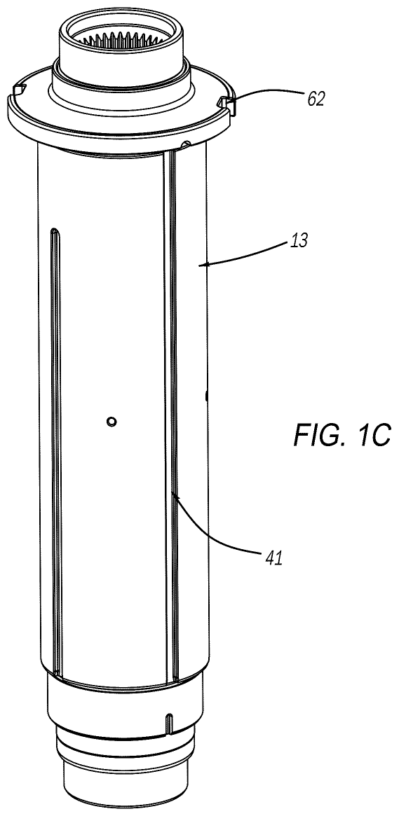

With reference to FIGS. 1A-1C, an electric converter is provided and is generally indicated by reference numeral 10. The electric converter 10 includes a stack of rotor cores 12 (FIGS. 1A and 1B) and a core shaft or shaft 13 (FIGS. 1A and 1C). The stack of rotor cores 12 may include a plurality of magnetizable inserts 14 disposed within cavities 16 of the rotor cores 12 (FIG. 1B). The cavities 16 of each rotor core 12 are circumferentially spaced apart around the rotor core 12 and are in fluid communication with the cavities 16 of other rotor cores 12 of the stack of rotor cores 12. For example, the cavities 16 of one of the rotor cores 12 are in fluid communication with the cavities 16 of an adjacent rotor core 12. In this way, the cavities 16 of the rotor cores 12 are in fluid communication with each other along an axial direction of the electric converter 10 such that adhesive material can flow through each of the cavities 16 during a molding process. Each rotor core 12 may be formed by a stack of laminations (not specifically shown) secured to each other. An example construction of an electric converter including the rotor cores is described in detail in U.S. Publication No. 2018/0287439, which has been incorporated herein by reference in its entirety. One example construction of an electric converter undergoing the molding process to secure the magnetizable inserts 14 to the rotor cores is disclosed in Applicant's co-pending application Ser. No. 18/673,217 which is commonly owned with the present application and the contents of which are incorporated herein by reference in its entirety.

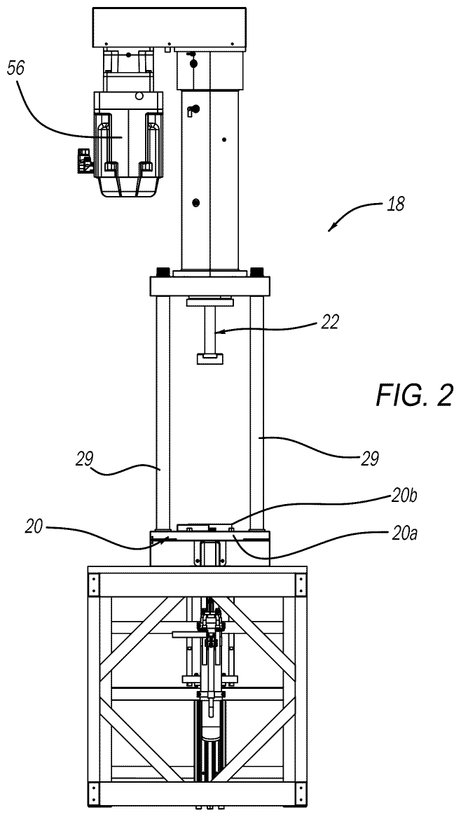

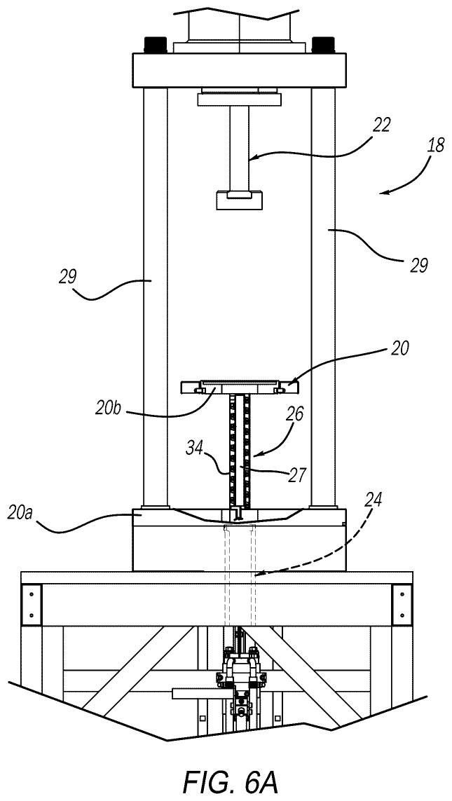

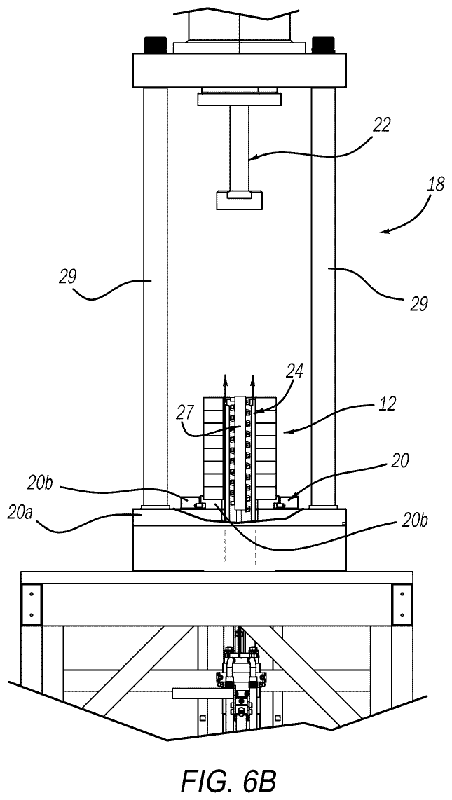

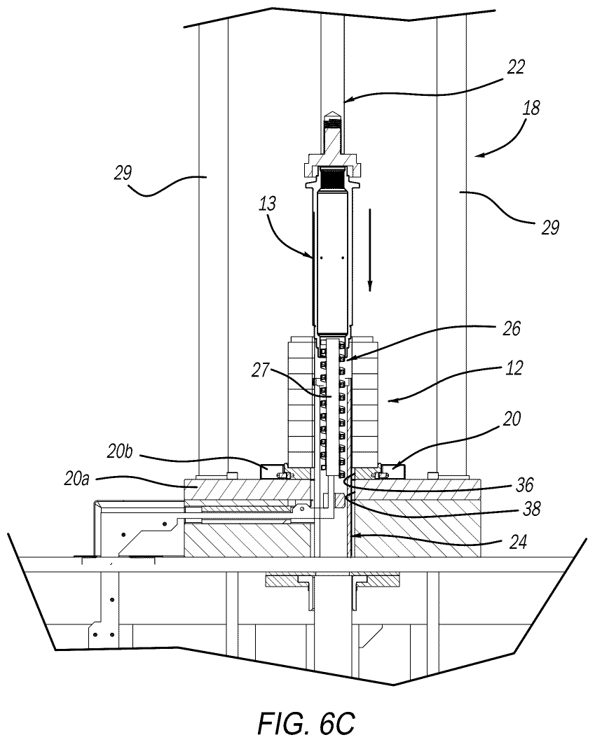

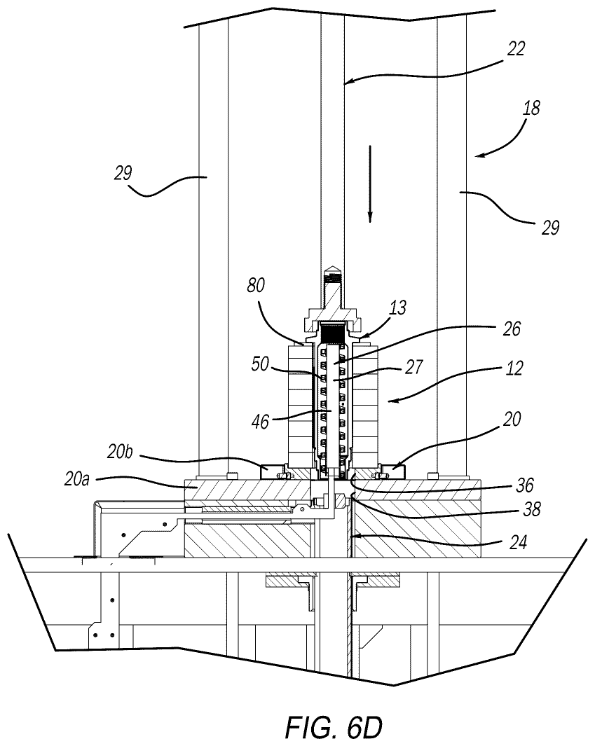

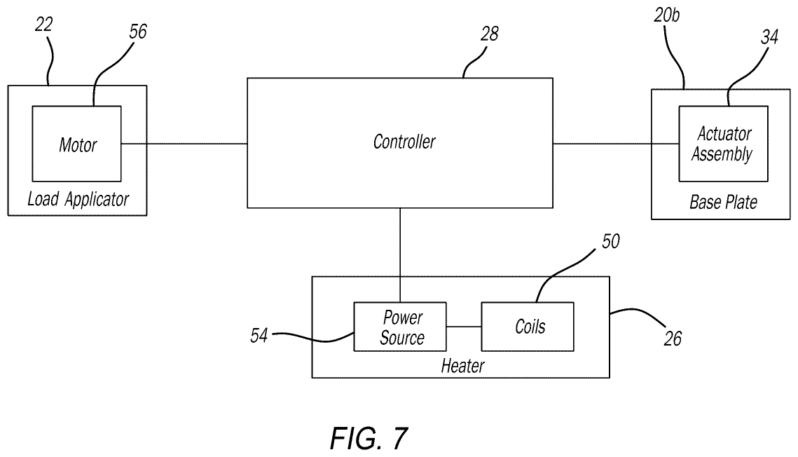

With reference to FIGS. 2 and 6A-6D, a system or tool assembly 18 for joining the stack of rotor cores 12 and the shaft 13 is provided. The stack of rotor cores 12 and the shaft 13 may be joined together using the system 18 after the stack of rotor cores 12 undergoes the molding process. That is, the stack of rotor cores 12 and the shaft 13 are joined together such that the stack of rotor cores 12 and the shaft 13 are fixed to each other (e.g., axially and rotationally fixed to each other). In one example, the stack of rotor cores 12 and the shaft 13 are joined together using an interference fit or shrink fit. The system 18 includes a base assembly 20, a load applicator 22, an alignment shaft 24, a heating assembly or heater 26, and a controller 28 (FIG. 7).

The base assembly 20 includes a support structure 20a and a base plate 20b. The support structure 20a is stationary (i.e., does not move) and may be fixed to one or more beams 29 of the system 18. In the example illustrated, the support structure 20a is fixed to the beams 29 using one or more fasteners. In some forms, the support structure 20a may be fixed to the beams 29 using welding, adhesives, or any other suitable attachment means. The base plate 20b supports the stack of rotor cores 12 as will be described in more detail below and is movable, via an actuator assembly 34, between a first position (FIG. 6A) in which the base plate 20b is removed from the support structure 20a and a second position (FIGS. 2 and 6B-6D) in which the base plate 20b engages or abuts the support structure 20a. That is, when the base plate 20b is in the first position, the base plate 20b is spaced apart from the support structure 20a and is supported by the actuator assembly 34, and when the base plate 20b is in the second position, the base plate 20b contacts the support structure 20a and is at least partially supported by the support structure 20a and the actuator assembly 34.

In the example illustrated, the base plate 20b includes a thickness that is less than a thickness of the support structure 20a. In some forms, the base plate 20b may include a thickness that is equal to or greater than a thickness of the support structure 20a. In the example illustrated, the base plate 20b has a surface area that is less than a surface area of the support structure 20a. In some forms, the base plate 20b has a surface area that is equal to a surface area of the support structure 20a. The base plate 20b also includes a central opening 36 that is aligned with a central opening 38 in the support structure 20a (FIG. 6C). The central openings 36, 38 of the base plate 20b and the support structure 20a, respectively, may receive the alignment shaft 24 and the heater 26 as will be described in more detail below.

The load applicator 22 is removably coupled to the shaft 13 and moves the shaft 13 between a first position (FIG. 6C) in which the shaft 13 is removed from the stack of rotor cores 12 (i.e., removed from an aperture 40 of the stack of rotor cores 12) and a second position (FIG. 6D) in which the shaft 13 is inserted into the aperture 40 of the stack of rotor cores 12. When the load applicator 22 is in the second position, the shaft 13 surrounds the heater 26. The load applicator 22 is removably secured to the shaft 13 such that the load applicator 22 may be detached or disconnected from the shaft 13 when the load applicator 22 is in the first position or second position. In one form, the load applicator 22 may be a press that is allowed to apply a load to the shaft 13 and the stack of rotor cores 12 as will be described in more detail below.

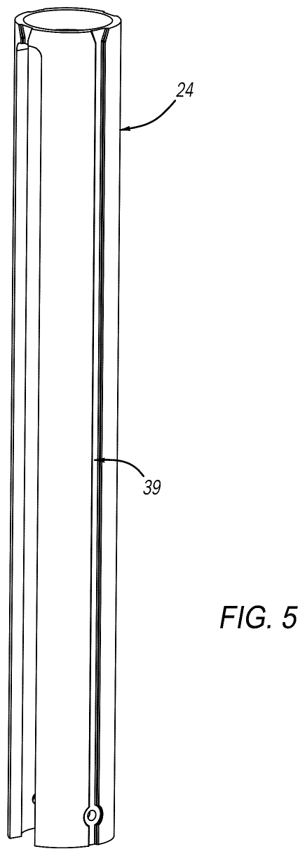

With reference to FIGS. 5 and 6A-6D, the alignment shaft 24 aligns the stack of rotor cores 12 and the shaft 13 to each other. That is, the inner periphery of the stack of rotor cores 12 may include protrusions 43 (FIG. 1B) that are received in keyways 39 (FIG. 5; e.g., grooves) of the alignment shaft 24 when the alignment shaft 24 is in the first state (FIG. 6B). In this way, the alignment shaft 24 rotationally aligns the stack of rotor cores 12 such that the protrusions of the stack of rotor cores 12 are received in keyways 41 (FIG. 1C; e.g., grooves) of the shaft 13 as the load applicator 22 is moved toward the second position and the alignment shaft 24 is moved toward the second state (FIG. 6D). The alignment shaft 24 extends through the central openings 36, 38 of the base plate 20b and the support structure 20a, respectively, when in the first state and may be removed from the central openings 36, 38 of the base plate 20b and the support structure 20a, respectively, when in the second state. In the example illustrated, the alignment shaft 24 is hollow and is also coaxial with the shaft 13 and the stack of rotor cores 12.

The alignment shaft 24 is movable between the first state (FIG. 6B) in which the alignment shaft 24 is inserted into the aperture 40 and surrounds the heater 26 and a second state (FIG. 6D) in which the alignment shaft 24 is removed from the heater 26 (i.e., separated from and not surrounding the heater 26). When in the second state, the alignment shaft 24 is removed from the aperture 40 in the stack of rotor cores 12. The alignment shaft 24 may be movable between the first state and the second state via an actuator such that the protrusions 43 of the stack of rotor cores 12 are removed from the keyways 39 of the alignment shaft 24 and are received in the keyways 41 of the shaft 13 as the load applicator 22 is moved toward the second position and the alignment shaft 24 is moved toward the second state. In this way, the shaft 13 is rotationally aligned with the stack of rotor cores 12 prior to being joined to the stack of rotor cores 12. In some forms, the alignment shaft 24 is biased toward the first state via a biasing member (e.g., spring). As the load applicator 22 is moved toward the second position with a predetermined force such that the shaft 13 is inserted into the aperture 40 of the stack of rotor cores 12, the predetermined force of the load applicator 22 overcomes a biasing force of the biasing element, thereby causing the shaft 13 to force the alignment shaft 24 from the aperture 40 of the stack of rotor cores 12.

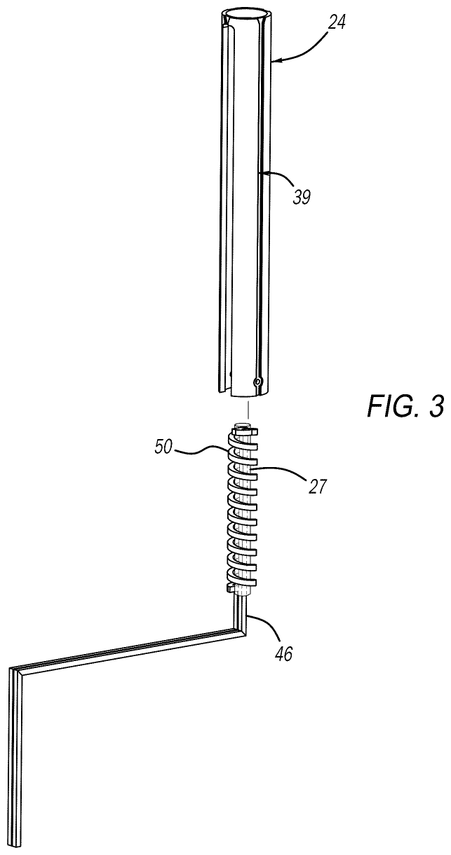

With reference to FIGS. 3, 4, 6C and 6D, the heater 26 extends through the central opening 38 of the support structure 20a and is spaced apart from the base assembly 20. The heater 26 is also disposed in the alignment shaft 24 when the alignment shaft 24 is in the first state, disposed in the stack of rotor cores 12 when the stack of rotor cores 12 are placed on the base assembly 20 and the base assembly 20 is in the second position, and disposed in the shaft 13 when the shaft 13 is inserted into the stack of rotor cores 12. The heater 26 is in a heat transfer relationship with the shaft 13 once the shaft 13 is inserted into the stack of rotor cores 12. In this way, the heating assembly 26 may heat the shaft 13 to facilitate joining of the shaft 13 and the stack of rotor cores 12 to each other as will be described in more detail below. In the example illustrated, the heater 26 is spaced apart from the shaft 13 when the shaft 13 is inserted into the stack of rotor cores 12 such that the heater assembly 26 heats the shaft 13 using radiation or convection, for example. In another example, the heater 26 may contact the shaft 13 to heat the shaft using conduction. In the example illustrated, the heater 26 is stationary (i.e., fixed) such that it is not allowed to move in a vertical or horizontal direction. In some forms, the heater 26 may move vertically or horizontally relative to the base assembly 20, the load applicator 22, and/or the alignment shaft 24.

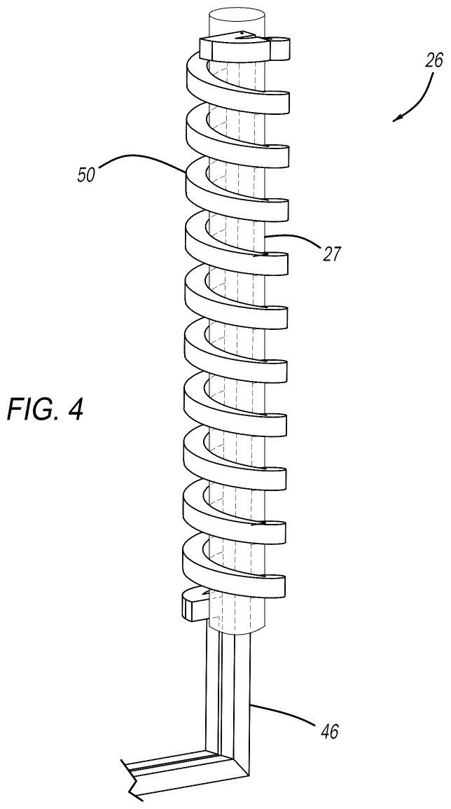

With reference to FIGS. 3 and 4, the heater 26 includes an inner core portion 46 and one or more heating elements or induction coils 50. The inner core portion 46 is made of a metal. A concentrator unit or structure 27 may be disposed over the inner core portion 46 and may act as a support for the coils 50. In the example illustrated, the inner core portion 46 has an axial length that is less than an axial length of the stack of rotor cores 12. In some forms, inner core portion 46 may have an axial length that is substantially equal to an axial length of the stack of rotor cores 12. In the example illustrated, the coils 50 extend through the support structure 20a and are wrapped around the concentrator structure 27. The coils 50 may also be electrically coupled to a power source 54 (FIG. 7). In this way, a current may be supplied to the heater 26 to heat coils 50, which, in turn, heats the shaft 13 inserted into the stack of rotor cores 12. In the example illustrated, the heater 26 generates heat using induction heating to heat the shaft 13 inserted into the stack of rotor cores 12. The coils 50 may include independently controlled zones such that different portions of the shaft 13 may be heated to different temperatures as desired. In some forms, the heater 26 may include resistance heating to heat the shaft 13 inserted into the stack of rotor cores 12. That is, the resistance heater may include a resistive wire instead of the coils to generate heat that heats the shaft 13 inserted into the stack of rotor cores 12. In the example illustrated, the heater 26 is formed using a single, monolithic heating element. In some forms, the heater 26 may be an assembly (e.g., inner core, outer core, and one or more heating elements) including one or more parts that cooperate with each other to generate heat.

With reference to FIG. 7, the controller 28 is in communication with a motor 56 of the load applicator 22, the power source 54 of the heater 26, and the actuator assembly 34 of the base plate 20b, and may monitor and control operations of the motor 56, the power source 54 and the actuator assembly 34 based on data received. That is, the controller 28 may instruct the load applicator 22 to move between the first and second positions and instruct the base plate to move between the first and second positions. The controller 28 may also control the current supplied to the coils 50, which controls the heat generated by the heater 26. In one example, the controller 28 is in communication with the load applicator 22, the heater 26, and the base plate 20b using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others). The motor 56 may be an electric motor, a hydraulic motor, or any other suitable motor capable of moving the load applicator 22 between the first position and second position.

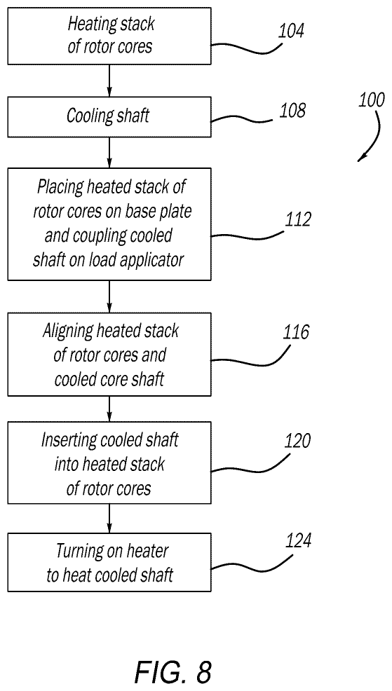

With reference to FIG. 8, an example control algorithm 100 for assembling the stack of rotor cores 12 to the shaft 13 using the system 18 is illustrated. The stack of rotor cores 12 and the shaft 13 may be joined together using the system 18 after the stack of rotor cores 12 undergoes the molding process. At 104, the stack of rotor cores 12 is heated to a predetermined temperature in a heating apparatus (not shown). In one example, the heating apparatus may be an oven. At 108, the shaft 13 is cooled to a predetermined temperature in a cooling apparatus (not shown). In one example, the cooling apparatus may be a liquid nitrogen vessel (e.g., liquid nitrogen cooling tank). It should be understood that the temperature difference between the heated stack of rotor cores 12 and the cooled shaft 13 may be predetermined. In one example, the temperature difference may be between 220 degrees Celsius and 280 degrees Celsius. For example, the stack of rotor cores 12 may be heated to approximately 180 degrees Celsius in the heating apparatus and the shaft 13 may be cooled to approximately −85 degrees Celsius in the cooling apparatus. In this way, a diameter of the aperture 40 of the stack of rotor cores 12 is greater than a diameter of the shaft 13, which, in turn, creates a clearance gap between the aperture 40 of the stack of rotor cores 12 and the shaft 13. The clearance gap allows the shaft 13 to be conveniently inserted into the aperture 40 of the stack of rotor cores 12 without impairing the stack of rotor cores 12. In one example, the clearance gap may be between 40 microns and 70 microns. It should also be understood that the clearance gap may be formed by performing one of the heating of the stack of rotor cores 12 and the cooling of the shaft 13 instead of performing both of the heating of the stack of rotor cores 12 and the cooling of the shaft 13.

At 112, the heated stack of rotor cores 12 are placed on the base plate 20b of the base assembly 20 and the cooled shaft 13 is coupled to the load applicator 22. In one form, a robot (not shown) may automatically remove the heated stack of rotor cores 12 from the heating apparatus and place the heated stack of rotor cores 12 on the base plate 20b once the heated stack of rotor cores 12 reach the predetermined temperature. In another example, a human operator may remove the heated stack of rotor cores 12 from the heating apparatus and place on the base plate 20b once the heated stack of rotor cores 12 reaches the predetermined temperature. In the example illustrated, the controller 28 instructs the actuator assembly 34 to move the base plate 20b to the first position in response to the stack of rotor cores 12 reaching the predetermined temperature, so that the stack of heated rotor cores 12 may be placed on the base plate 20b. In some forms, the controller 28 may instruct the actuator assembly 34 to move the base plate 20b to the second position in response to the stack of rotor cores 12 reaching the predetermined temperature, so that the stack of heated rotor cores 12 may be placed on the base plate 20b.

In one form, a robot (not shown) may automatically remove the cooled shaft 13 from the cooling apparatus and couple the cooled shaft 13 to the load applicator 22 once the cooled shaft 13 reaches the predetermined temperature. In another example, a human operator may remove the cooled shaft 13 from the cooling apparatus and couple to the load applicator 22 once the cooled shaft 13 reaches the predetermined temperature. It should be understood that the controller 28 is in communication with the heating apparatus and cooling apparatus and may receive data relating to the temperatures of the stack of rotor cores 12 and the shaft 13.

At 116, the heated stack of rotor cores 12 and the cooled shaft 13 are aligned with each other. Once the base plate 20b including the stack of heated rotor cores 12 thereon moves to the second position, the alignment shaft 24 rotationally aligns the stack of heated rotor cores 12 and the shaft 13 as described above. At 120, the control algorithm, using the controller 28, instructs the load applicator 22 to move from the first position to the second position using a predetermined force. In this way, the cooled shaft 13 is inserted into the aperture 40 of the heated stack of rotor cores 12. The load applicator 22 may be held in the second position for a predetermined time period.

It should be understood that the shaft 13 includes a radially extending flange 62 that abuts against a cap 80 secured to the stack of heated rotor cores 12. In this way, the flange 62 and the base plate 20b may cooperate to further compress the stack of heated rotor cores 12 when the load applicator 22 is in the second position.

At 124, the control algorithm, using the controller 28, turns on the heater 26 to heat the cooled shaft 13 in response to the load applicator 22 being in the second position. In this way, the temperature of the heated shaft 13 begins to equalize with the temperature of the stack of heated rotor cores 12 causing the shaft 13 and the stack of rotor cores 12 to join together. Stated differently, the temperature of the heated shaft 13 begins to equalize with the temperature of the stack of heated rotor cores 12 such that the stack of rotor cores 12 and the shaft 13 are fixed to each other (e.g., axially and rotationally fixed to each other). In one example, turning on the heater 26 includes pulsating a current to the coils 50. In another example, turning on the heater 26 includes providing a steady current to the coils 50.

Once the shaft 13 and the stack of rotor cores 12 are joined to each other, the controller 28 may instruct the load applicator 22 to move from the second position to the first position and the base plate 20b to move from the second position to the first position. In this way, the electric converter 10 can be removed from the base plate 20b and the process for joining another stack of rotor cores 12 and shaft 13 may begin. It should be understood that the shaft 13 is hollow such that the heater 26 may be receive therein once the shaft 13 is inserted into the stack of rotor cores 12.

The present disclosure provides a method and a system 18 for assembling the stack of rotor cores 12 and the shaft 13 to each other, thereby reducing time of the assembly process. That is, the stack of rotor cores 12 and the shaft 13 may be assembled to each other in 30 seconds, for example, once the shaft 13 is inserted into the aperture 40 of the stack of rotor cores 12.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of assembling an electric converter, the method comprising:
placing a stack of rotor cores on a base plate of a tool assembly;
inserting a core shaft into an aperture of the stack of rotor cores so that the stack of rotor cores and the core shaft surround a heater; and
turning on the heater to heat the core shaft such that the stack of rotor cores and the heated core shaft are joined together,
wherein a diameter of the aperture of the stack of rotor cores is greater than a diameter of the core shaft prior to inserting the core shaft into the aperture of the stack of rotor cores.

2. The method according to claim 1, further comprising aligning the stack of rotor cores and the core shaft prior to inserting the core shaft into the aperture of the stack of rotor cores.

3. The method according to claim 2, wherein the core shaft is cooled prior to being inserted into the aperture of the stack of rotor cores so that the diameter of the aperture of the stack of rotor cores is greater than the diameter of the core shaft.

4. The method according to claim 1, wherein turning on the heater includes pulsating a current supplied to the heater.

5. The method according to claim 1, wherein the base plate and the core shaft cooperate to compress the stack of rotor cores in response to the core shaft being inserted into the aperture of the stack of rotor cores.

6. The method according to claim 1, wherein the stack of rotor cores is heated prior to the core shaft being inserted into the aperture of the stack of rotor cores so that the diameter of the aperture of the stack of rotor cores is greater than the diameter of the core shaft.

7. The method according to claim 1, wherein the core shaft is hollow, and wherein the heater includes an induction coil disposed within the hollow core shaft.

8. A method of assembling an electric converter, the method comprising:
heating a stack of rotor cores to a first temperature and cooling a core shaft to a second temperature, the second temperature being less than the first temperature so that a diameter of an aperture of the heated stack of rotor cores is greater than a diameter of the cooled core shaft;
placing the heated stack of rotor cores on a base plate of a tool assembly;
inserting the cooled core shaft into the aperture of the heated stack of rotor cores so that the heated stack of rotor cores and the cooled core shaft surround a heater, the base plate and the cooled core shaft cooperate to compress the heated stack of rotor cores when the cooled core shaft is inserted into the aperture of the heated stack of rotor cores; and
turning on the heater to heat the cooled core shaft such that the heated stack of rotor cores and the heated core shaft are joined together.

9. The method according to claim 8, further comprising aligning the heated stack of rotor cores and the cooled core shaft prior to inserting the cooled core shaft into the aperture of the heated stack of rotor cores.

10. The method according to claim 8, wherein turning on the heater includes pulsating a current supplied to the heater.

11. The method according to claim 8, wherein the heated stack of rotor cores and the heated core shaft are joined together by an interference fit.

12. The method according to claim 8, wherein the base plate is movable between a first position in which the base plate is removed from the heater and a second position in which the base plate surrounds the heater, the heated stack of rotor cores is placed on the base plate when the base plate is in the first position and the cooled core shaft is inserted into the aperture of the heated stack of rotor cores when the base plate is in the second position.

13. The method according to claim 8, wherein the core shaft is hollow, and wherein the heater includes an induction coil disposed within the hollow core shaft.

14. A system for assembling an electric converter comprising a stack of rotor cores and a core shaft, the system comprising:
a heater;
a base plate surrounding the heater and configured to support the stack of rotor cores;
a load applicator configured to engage and move the core shaft between a first position in which the core shaft is removed from the stack of rotor cores and a second position in which the core shaft is inserted into the stack of rotor cores and surrounding the heater; and
a controller in communication with the heater and the load applicator, the controller configured to:
instruct the load applicator to move from the first position to the second position; and
turn on the heater in response to the load applicator being moved to the second position.

15. The system according to claim 14, further comprising an alignment shaft configured to align the stack of rotor cores and the core shaft and movable between a first state in which the alignment shaft surrounds the heater and a second state in which the alignment shaft is removed from the heater.

16. The system according to claim 15, wherein the alignment shaft is biased towards the first state via a biasing element, and wherein when the load applicator moves from the first state to the second state, the load applicator overcomes a biasing force of the biasing element to move the alignment shaft from the first state to the second state.

17. The system according to claim 14, wherein the heater includes an induction coil.

18. The system according to claim 14, wherein:
the base plate is movable between a first position in which the base plate is removed from the heater and a second position in which the base plate surrounds the heater; and
the controller is in communication with the base plate and configured to:
instruct the base plate to move from the first position to the second position; and
instruct the load applicator to move from the first position to the second position in response the base plate being moved to the second position.

19. The system according to claim 14, wherein the heater is fixed.

20. The system according to claim 14, wherein turning on the heater includes pulsating a current supplied to the heater.
